(19) United States
(12) Patent Application Publication
(10) Pub. No.: US 2011/0265616 A1
(43) Pub. Date: Nov. 3, 2011

(54) ULTRA-PURE, SINGLE-CRYSTAL SIC CUTTING TOOL FOR ULTRA-PRECISION MACHINING

(75) Inventors: Wolfgang J. Choyke, Pittsburgh, PA (US); Robert P. Devaty, Pittsburgh, PA (US); Brian D'Urso, Pittsburgh, PA (US); Fei Yan, Pittsburgh, PA (US)

(73) Assignee: University of Pittsburgh-Of the Commonwealth System of Higher Education, Pittsburgh, PA (US)

(21) Appl. No.: 13/097,767

(22) Filed: Apr. 29, 2011

Related U.S. Application Data
(60) Provisional application No. 61/329,603, filed on Apr. 30, 2010.

(51) Int. Cl. B23B 1/00; B23B 27/14; B23P 15/30; B23C 5/16

(52) U.S. Cl. 82/1.11; 407/119; 407/53; 29/592

(57) ABSTRACT

Systems and methods that use a single-crystal boule SiC sharpened into a cutting tool for ultra-precision machining of ferrous alloys are disclosed. Conventional ultra-precision machining uses single-crystal natural diamond. Despite the exceptional mechanical properties of diamond, its chemical properties have inhibited the extension of ultra-precision machining to iron-containing (ferrous) alloys. A single-crystal SiC cutting tool can be used to cut many materials for which diamond cutting tools are conventionally used. Additionally, a single-crystal SiC cutting tool can be used to cut materials for which diamond cutting tools are inappropriate, such as ferrous metals or nickel.

### CROSS-REFERENCE TO RELATED APPLICATIONS

This application claims the benefit of U.S. Provisional Patent application Ser. No. 61/329,603 entitled “ULTRA-PURE, SINGLE-CRYSTAL SIC CUTTING TOOL FOR ULTRA-PRECISION MACHINING” and filed Apr. 30, 2010. The entirety of the above-noted application is incorporated by reference herein.

### BACKGROUND

Ultra-precision machining has advanced significantly over the last several decades with improvements in design, computer control, and precision measurements, but the cutting tool of choice has remained unchanged; it is single-crystal natural diamond. Despite the exceptional mechanical properties of diamond, its chemical properties have inhibited the extension of ultra-precision machining to iron-containing (ferrous) alloys, nickel alloys, and many other materials such as silicon.

The workhorse of ultra-precision machining is the ultra-precision lathe (UPL). When used with a single-crystal diamond cutting tool, the machining process is known as single point diamond turning (SPDT). While single-crystal diamond cutting tools are useful, there is a need in the art to enhance precision for specific applications and ultra-precision machining utilizing UPLs.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

Ultra-precision machining is dominated by single-crystal diamond cutting tools, and is typically applied to a narrow range of materials, particularly aluminum and copper. Single-crystal SiC, although nearly as hard as diamond and comparable to some diamonds in thermal conductivity, while having superior chemical and thermal stability, has not been explored as a cutting tool for ultra-precision machining. The innovation, in aspects thereof, discloses several cutting tools manufactured with single-crystal SiC, either with sharp corners or with a circular radius. In operation, the innovation can be used to cut surfaces of a variety of materials, including ferrous metals (e.g., 316 stainless steel), nickel, and silicon. These materials generally cause unacceptably rapid diamond tool wear.

The specification discloses a tool for ultra-precision machining including ferrous or non-ferrous metals which uses a single crystal of SiC, such as low-doped and low-defect 4H or 6H SiC. The crystal may be sharpened at the cutting edge and may take most any of the shapes conventionally used with single crystal diamond cutting tools. This includes, but is not limited to, cutting tools for use on an ultra-precision lathe such as radius tools, dead sharp tools, flat tools, and micro-milling tools such as ball end mills, flat end mills, and sharp end mills. The single crystal of SiC may be mounted or held on a shank or cylinder for convenient holding in the machining equipment by most any method including, but not limited to, clamping, brazing, soldering, gluing, or welding.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates, in an aspect of the innovation, a single-crystal silicon carbide (SiC) cutting tool that can be used for ultra-precision machining.

FIG. 2 illustrates an example of an ultra-precision lathe that can be used in conjunction with the innovation described herein.

FIG. 3 illustrates a close-up of a portion of a UPL that can be used in connection with aspects of the innovation.

FIG. 4 illustrates an example single-crystal SiC cutting tool with a sharp-cornered SiC crystal.

FIG. 5 illustrates an example single-crystal SiC cutting tool with a SiC crystal having a relatively large cutting edge.

FIG. 6 illustrates an example 316 stainless steel cylinder end cut with a high-speed steel tool on a conventional lathe.

FIG. 7 illustrates an example 316 stainless steel cylinder end cut with the sharp-cornered single-crystal 6H SiC tool on an ultra-precision lathe according to aspects of the subject innovation.

FIG. 8 illustrates a surface map of the sample shown in FIG. 7 measured with a Zygo interferometer.

FIG. 9 illustrates an example surface map of a portion of the end of a 316 stainless steel cylinder cut with the large radius single-crystal 4H SiC cutting tool according to aspects of the subject innovation.

FIG. 10 illustrates an example surface map of a portion of the end of a nickel cylinder cut with the large radius 4H SiC single-crystal cutting tool in an embodiment of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

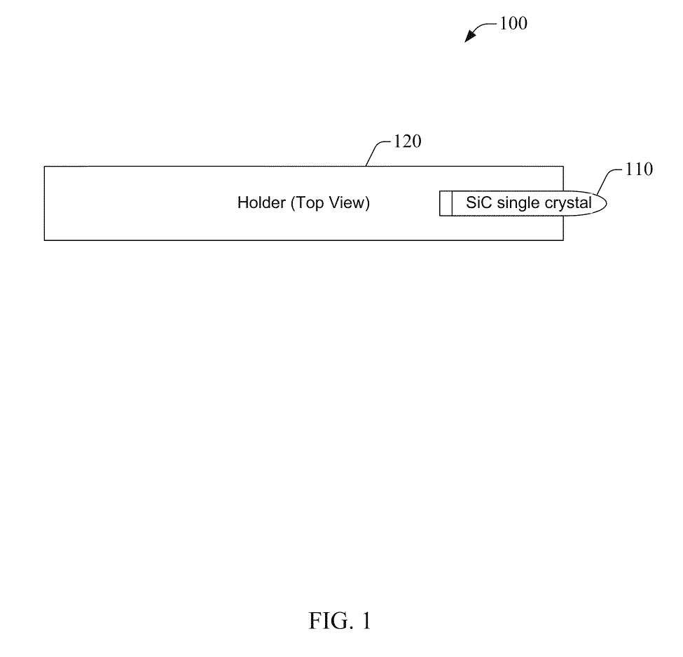

Turning to the drawings, FIG. 1 illustrates, in an aspect of the innovation, a single-crystal silicon carbide (SiC) cutting tool 100 that can be used for ultra-precision machining. Tool 100 can comprise a single crystal of SiC 110 that can be polished to a sharp edge. Additionally, tool 100 can further comprise a holder 120 in which the single crystal of SiC can be mounted. The single crystal of SiC 110 can be of any of the polymorphs of SiC (e.g., 4H, 6H, etc.), and specific experiments involving tools constructed using single crystals of the 4H and 6H polymorphs of SiC are discussed further herein. Optionally, this tool can be mounted in an ultra-precision lathe such as is described herein. In some aspects, the innovation can include an ultra-precision machine (such as a UPL) with a single-crystal cutting tool such as tool 100.

Tool 100 can be used in most applications for which diamond cutting tools are used (e.g., lathes, turn-mills, rotary transfers, milling, grinding, honing, etc.). For example, single point diamond turning (SPDT), as discussed further herein, involves the use of a single-crystal diamond in an ultra-precision lathe, and many of the applications of SPDT and materials that SPDT can be used on can also be done with a single-crystal SiC such as crystal 110. Additionally, a tool such as tool 100 can be used in applications that diamond tools, because of their chemical interactions, are not able to be used. Applications for which diamond tools are generally unsuitable include working with ferrous metals (e.g., iron or steel), nickel, silicon or silicon based glasses, beryllium, titanium, molybdenum, etc. A tool such as tool 100 can be used in many such applications with less tool wear than a diamond tool, because the SiC crystal of tool 100 is less chemically reactive than a single-crystal diamond. In addition, even in applications that can cause relatively rapid tool wear, tool 110 can also be advantageous over a diamond tool due to the relatively low cost of replacement of crystal 110 as compared with a single-crystal diamond, especially a natural diamond.

Various parameters and choices as explained herein can be selected to optimize performance of the tool in various applications. For example, the orientation of the crystal can be chosen to optimize performance of the tool. Performance can be improved in one or more ways, and optimizing performance can include improvements in one or more of reducing surface roughness (e.g., measured by Ra as discussed herein), reducing wear on the tool, reducing a probability or incidence of the tool breaking, increasing efficiency, etc. Depending on the specifics of the application of the tool (e.g., type of use, such as in a UPL, type of material it is used on, cutting parameters, etc.), specific orientations of the crystal may be advantageous, such as (0001), (000 1̅), (1 1̅00), (11 2̅0), etc. Although specific orientations are mentioned in connection with experiments discussed herein, it is to be understood that in other situations, different orientations may be more advantageous. Additionally, depending on the chosen application and setting, other selections can be made to improve tool performance as discussed herein, for example, selections related to cutting parameters, shape of the cutting surface, choice of SiC polymorph, etc.

In other embodiments, the innovation can include a method of making a single-crystal SiC cutting tool such as tool 100. In an optional initial step, a boule of SiC can be grown or formed through substantially any means known in the art (e.g., the modified Lely method). Depending on the application, different polymorphs of SiC can be selected, such as 4H, 6H, etc. If necessary (e.g., if a large boule of SiC was grown), a smaller single crystal of SiC can be cut from the boule. In other aspects, a crystal of the appropriate size can be obtained elsewhere (selected, purchased, etc.). The size (e.g., dimensions) of this crystal of SiC can be selected based on parameters associated with the use. For example, if it is to replace a single-crystal diamond in a cutting tool, it can be of the same size as the diamond crystal. In other situations, the size of the crystal can be determined based on a holder to be used.

Optionally, a specific orientation of the crystal can be selected based at least in part on an application of the tool (such as (0001), (000 1̅), (1 1̅00), (11 2̅0), etc.). In some embodiments, the selection of orientation can relate to and affect how the cutting surface is to be selected and shaped, and, alternatively or additionally, can affect the placement of the crystal in the holder. One or more of these aspects—how the cutting surface is to be selected and shaped, the placement of the crystal in the holder, or other aspects (e.g., selection of cutting parameters in applications, etc.)—can be based at least in part on the selection of crystal orientation. The single crystal of SiC can be shaped in a variety of means, such as by cutting an angle and side bevels, or by fabricating a larger cutting edge with a radius of curvature. The shaped crystal can be polished, for example with a variety of diamond pastes of various sizes. Additionally, the shaped crystal can be mounted in a holder. In some aspects, the holder can also be fabricated, and can be made of a variety of materials (e.g., steel). The assembled tool, including the shaped and polished crystal as well as the holder, can be used in a variety of applications as described herein.

The crystal may be sharpened at the cutting edge and may take most any of the shapes conventionally used with single crystal diamond cutting tools. This includes, but is not limited to, cutting tools for use on an ultra-precision lathe such as radius tools, dead sharp tools, flat tools, and micro-milling tools such as ball end mills, flat end mills, and sharp end mills. The single crystal of SiC may be mounted or held on a shank or cylinder for convenient holding in the machining equipment by most any method including, but not limited to, clamping, brazing, soldering, gluing, or welding.

In other embodiments, the innovation can include methods of using a single-crystal SiC cutting tool such as tool 100 to shape a sample via ultra-precision machining. As an optional initial step, a single-crystal SiC cutting tool such as tool 100 can be installed in an ultra-precision machine (e.g., a UPL). Optionally, the manner in which the cutting tool is installed can depend upon a specific orientation of the crystal, which can be selected based at least in part on an application of the tool (such as (0001), (000 1̅), (1 1̅00), (11 2̅0), etc.). This orientation can be selected to optimize performance of the tool based on the application (e.g., sample material, cutting parameters, etc.). The sample can be mounted in a working area of the ultra-precision machine (e.g., a UPL). Parameters for working on the sample can be selected, such as position of the cutting tool, spindle speed, feed rate, and depth of cut. The single-crystal SiC cutting tool can then cut the sample according to the parameters. In some aspects, the parameters can be varied during the cutting process, and can be varied based on known techniques. For example, computer numerical control (CNC) can be used to adjust the position of the cutting tool automatically according to a defined pattern or program. In aspects, CNC can control the parameters based at least in part on a design created via one or more of computer-aided design (CAD) or computer-aided manufacturing (CAM) so as to machine the sample according to a design created based on the one or more of CAD or CAM. Additionally, a coolant can be sprayed on the crystal and sample surface (e.g., a mist of odorless mineral spirits and compressed air). In addition to reducing heating, the coolant can also clear off the chip of material as it is cut.

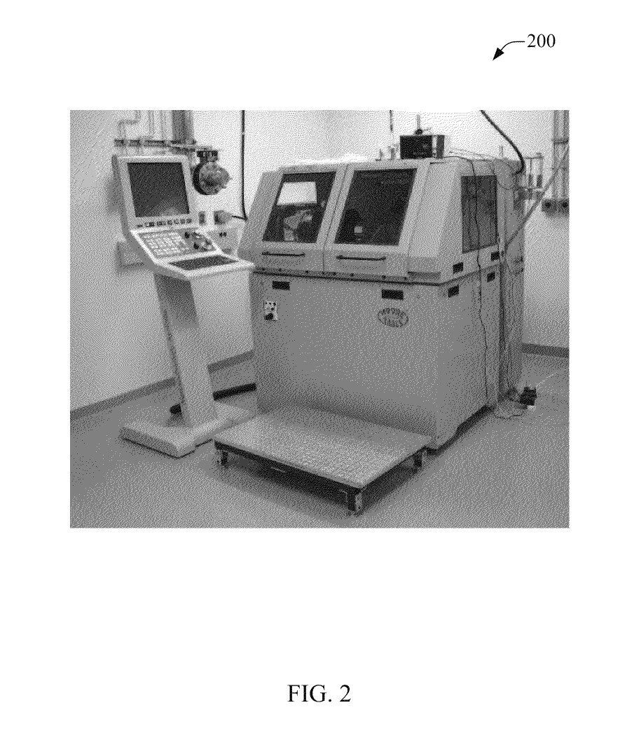

FIG. 2 illustrates a Moore Nanotech 250 ultra-precision lathe (UPL) 200, an example of a UPL that can be used in conjunction with the innovation described herein. Various experiments discussed herein were conducted on a Moore Nanotech 250 UPL such as the one shown at item 200 of FIG. 2. As described herein, in aspects, the innovation can be used in connection with a variety of ultra-precision machining, including via UPL. Various aspects of UPL 200 are illustrative of ways in which ultra-precision machining can be accomplished, such as ultra-precision machining using a single-crystal SiC cutting tool in accordance with aspects of the present innovation. UPL 200 uses hydrostatic oil-bearing slides and an air-bearing spindle to eliminate mechanical contact between its moving parts (see FIG. 2). The spindle motor of UPL 200 is brushless and the slides are coupled magnetically with linear motors to avoid mechanical drive mechanisms which could introduce jitter. As will be understood, UPL 200 can be programmed with a resolution of 1 nm, can routinely cut surfaces to a local surface roughness of 1 to 2 nm in select materials, and can cut a large area to within tens of nm of the programmed dimensions.

Single crystal diamonds have conventionally been used as cutting tools because of their hardness, strength, and high thermal conductivity. These properties contribute to the ability of a diamond to hold a precision, polished cutting edge and to carry away the heat generated during the cutting process. However, diamonds are unsuitable for applications with a range of materials. In aspects, the subject innovation discloses systems and methods capable of ultra-precisions machining of materials, including materials for which single-crystal diamond tools are incapable of ultra-precision machining.

Materials that are commonly cut with SPDT include non-ferrous metals (e.g., aluminum, copper, brass, silver), polymers (e.g., polymethylmethacrylate, polystyrene), and even some hard crystals (e.g., zinc sulfide, zinc selenide, germanium, and to a lesser extent, silicon). For low surface roughness, the cutting must occur in the ductile regime. This may require very careful choices of cutting parameters, but it has been shown that it is even possible to cut SiC with SPDT. Unfortunately, some materials cause unacceptably rapid diamond tool wear due to their hardness (e.g., mechanical wear) or due to chemical reactions involving the diamond tip and the surface being cut at the tip of the tool (e.g., chemical wear). Wear on the cutting edge can be exacerbated by the possibility of large forces and high temperatures at the cutting edge. The subject innovation is capable of addressing some of these scenarios.

Ferrous alloys include some of the highest-performance metals available, but they are particularly problematic for SPDT. Chemical reactions involving the diamond tool and iron rapidly wear the cutting edge, making SPDT of steels and other ferrous alloys impractical. Many potential solutions to this problem have been explored, including cooling with liquid nitrogen, coating the diamond with wear-resistant layers, ultrasonic vibration of the tool tip, or cutting in an inert atmosphere. While some of these techniques help to decrease tool wear, none has yet proven practical. Nickel alloys have similar problems. While electroless nickel can be successfully cut with SPDT, standard nickel alloys lead to unacceptably fast diamond tool wear. SPDT of silicon is of great interest to the semiconductor industry for rapid preparation of silicon wafers.

Single-crystal SiC has many similarities to diamond in terms of hardness and thermal conductivity, but is superior with respect to its increased chemical stability as compared to diamond. Because of these characteristics, sharpened ultra-pure single-crystal boule SiC can be used as described herein in cutting tools for ultra-precision machining. High quality, low doped, boule grown SiC can have an equivalent thermal conductivity to that of the type of diamonds currently used for ultra-precision machining. In addition, low defect single crystal SiC can be superior to any of the varieties of polycrystalline SiC materials currently available.

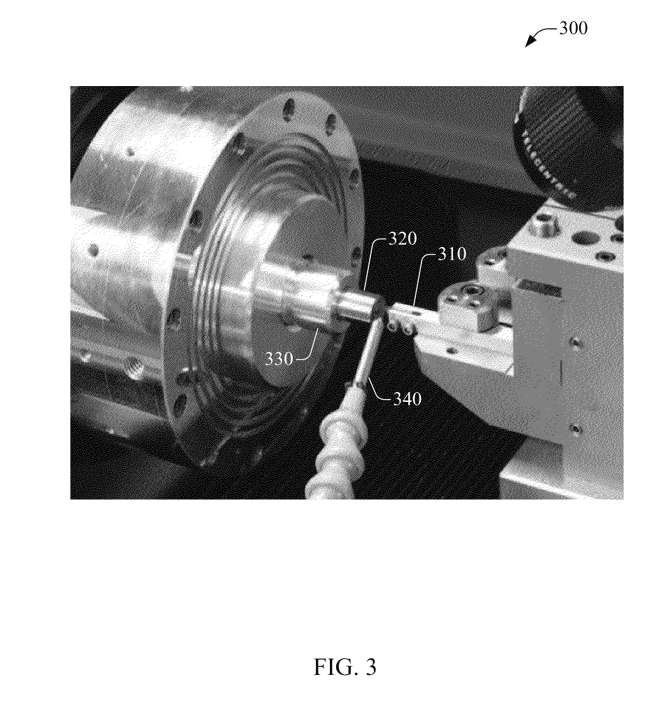

In accordance with the innovation described herein, FIG. 3 illustrates a close-up 300 of a portion of UPL 200 that can be used in connection with aspects of the innovation. FIG. 3 shows an example of a set-up that can be used to perform ultra-precision machining of samples with a UPL. In this example set-up, a SiC cutting tool 310 in an ultra-precision lathe can be used to cut a sample 320 (the sample shown is stainless steel, however, other materials can be used as discussed herein) mounted on the spindle 330 with a nozzle 340 for spraying a coolant mist. SiC cutting tool 310, such as the single-crystal SiC cutting tool in aspects of the subject innovation, can be controlled as described herein to cut sample 320, which is turned on spindle 330. Nozzle 340 can spray any of a variety of coolants, including but not limited to the mist of odorless mineral spirits and compressed air discussed herein. The experimental results discussed herein were obtained with a setup such as that shown in FIG. 3.

To aid in the understanding of aspects of the subject innovation, experimental results associated with specific experiments that were conducted are discussed herein. However, although for the purposes of obtaining the results discussed herein, specific choices were made as to the selection of various aspects of the experiments and associated setups—such as choice of specific tool structures, specific polymorphs of SiC, or materials to be tested—the systems and methods described herein can be employed in other contexts, as well.

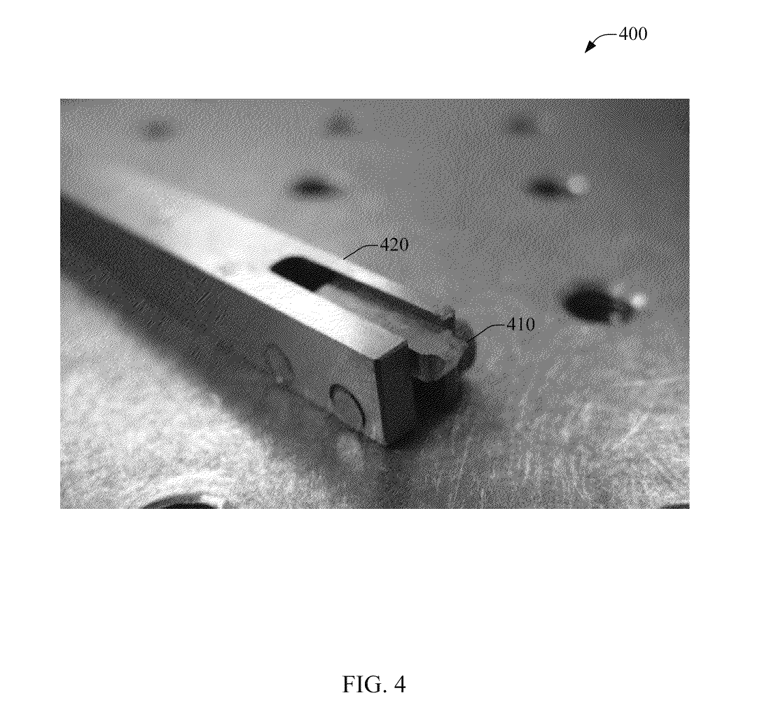

FIG. 4 illustrates an example single-crystal SiC cutting tool 400 with a sharp-cornered SiC crystal 410. This example sharp-cornered SiC cutting tool 400 utilizes a single crystal of 6H SiC 410 polished to a sharp cutting edge, mounted in a steel holder and shank 420. As should be understood, different materials can be used for the holder and shank, and other polymorphs of SiC can also be used. Crystal 410 was shaped from a 2.5×2.9 mm² strip of single crystal 6H SiC cut from a basal plane slice of n-type 6H SiC doped to 5×10¹⁵ cm⁻³. However, as explained above, in different settings, other crystal orientations can be chosen to optimize tool performance depending upon the application (e.g., (0001), (000 1̅), (1 1̅00), (11 2̅0), etc.). Although these specific parameters and choices were associated with crystal 410 in cutting tool 400, it should be understood that they can be varied; for example, variations can include other size crystals, other polymorphs of SiC, other planes, other amounts of doping (e.g., substantially any concentration, more or less than 5×10¹⁵ cm⁻³), etc. The front of the 6H SiC crystal 410 in tool 400 was cut to about a 10° angle from the vertical axis, although depending on the application or use, other angles may be used, as well. Side bevels were fabricated on crystal 410 with a diamond loaded abrasive Dremel Tool prior to polishing, although other methods could be used. The two surfaces that intersect to make up the cutting edge of crystal 410 were polished with a succession of diamond pastes of increasing fineness, starting with a 30 μm paste, then a 15 μm, 6 μm, 3 μm, 1 μm, and ½ μm diamond paste. Other means of polishing, including but not limited to other successions of diamond pastes, may be used alternatively or additionally. The back end of the single crystal 6H SiC 410 of tool 400 was held in a specially fabricated holder 420 that, in the experiment, was made of steel, although other materials may be used.

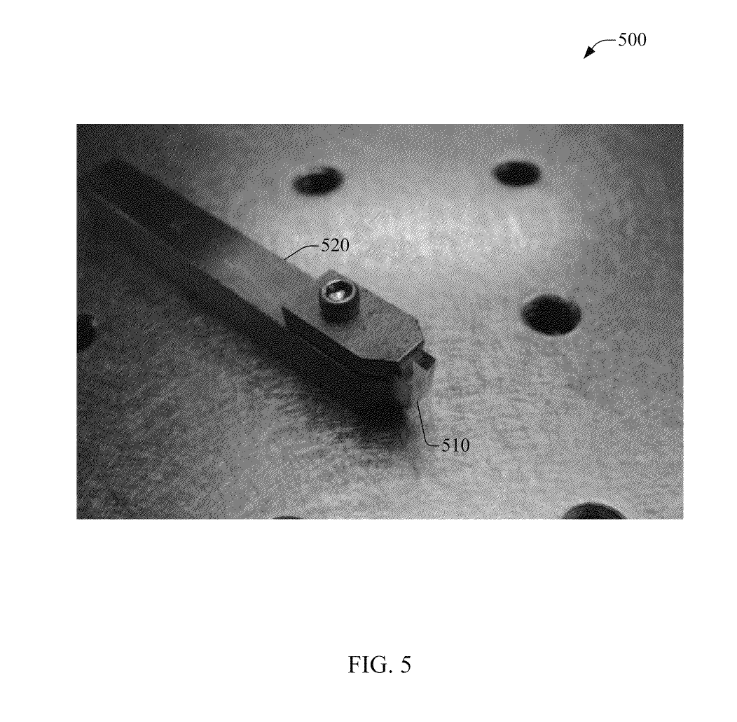

FIG. 5 illustrates an example single-crystal SiC cutting tool 500 with a SiC crystal 510 having a larger cutting edge than the tool in FIG. 4. Tool 500 of FIG. 5 is a similar tool to tool 400 of FIG. 4, with a crystal 510 also mechanically mounted in a holder 520 (again, steel was used, although other materials can be substituted). However, tool 500 uses single crystal 4H SiC 510 polished to a sharp edge with a large circular radius instead of crystal 410. Additional tools such as tool 500 can be and were made in a similar fashion to the fabrication of tool 400, but out of single crystal 4H SiC. Additionally, instead of sharp corners as with tool 400, tool 500 illustrates that tools can be fabricated to have a large cutting edge (e.g., with a radius of curvature ranging from around 0.1 mm or smaller to around 20 mm or larger). Such a cutting tool as tool 500 can provide for a wider and potentially smoother cut than tool 400. A cutting tool with a shape such as that of tool 500 is known as a radius tool. Additionally, as shown in FIGS. 4 and 5, holders 420 and 520 can include adjustable portions for securing crystals 410 and 510.

In one experiment, a flat surface was cut on the end of a 12.7 mm diameter, 316 stainless steel rod in a UPL. For this experiment, the UPL used was the one depicted in FIGS. 2 and 3, using the sharp-cornered 6H SiC cutting tool 400 shown in FIG. 4. To obtain the results discussed herein, the spindle speed was 2000 rpm, with a feed rate of 1 μm per revolution and a 4 μm depth of cut. Of course, these parameters can be varied. The SiC crystal and stainless steel surface were cooled with a sprayed mist of odorless mineral spirits (OMS) and compressed air, which also served to clear off the chip of material as it was cut.

In additional experiments, cutting tool 400 was replaced with the large radius 4H SiC cutting tool 500, and several more surfaces were cut on 316 stainless steel rods. The cuts performed with the large radius 4H SiC cutting tool 500 were generally lighter to keep the cutting forces low, despite the much larger cutting surface of the large radius tool. In one of the experiments with cutting tool 500, a surface was cut at a spindle speed of 2000 rpm, a feed rate of 1 μm per revolution and a 1 μm depth of cut. In other experiments, additional surfaces were cut while tripling the feed rate to 3 μm per revolution and maintaining a 1 μm depth of cut, or tripling the depth of cut to 3 μm and maintaining a feed rate of 1 μm per revolution. In one experiment, these same cutting parameters were used again with a nickel sample, with a depth of cut of 3 μm and a feed rate of 1 μm per revolution on a nickel rod. Additional experiments were performed on silicon with a radius tool and similar cutting parameters.

The initial experiments cutting 316 stainless steel with the sharp-cornered 6H SiC tool 400 showed that the sharp single-crystal 6H SiC tool could cut a smooth, minor like finish on a 316 stainless steel rod. Compared to the finish from cutting with a high-speed steel tool on a conventional lathe, the SiC tool on the UPL gave noticeably improved results with no indication of wear after several cuts across the surface. Additionally, no significant difference was seen in the quality of finish on stainless steel compared to aluminum with the 6H SiC tool 400.

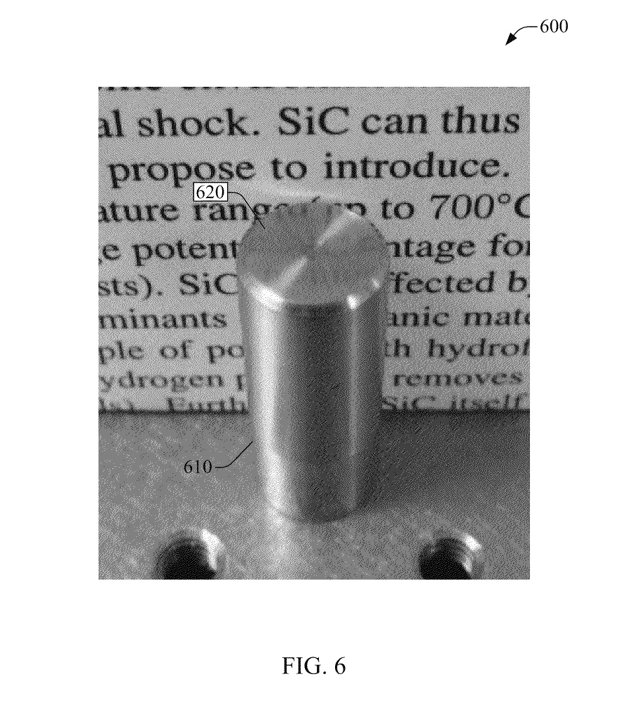

Turning to FIG. 6, illustrated is a picture 600 of an example 316 stainless steel cylinder 610 end cut with a high-speed steel tool on a conventional lathe. The top end 620 is the end that was cut by the high-speed steel tool. As discussed above, conventional UPL cutting uses single-crystal diamonds, and does not allow for cutting of a variety of materials, including ferrous metals such as 316 stainless steel cylinder 610.

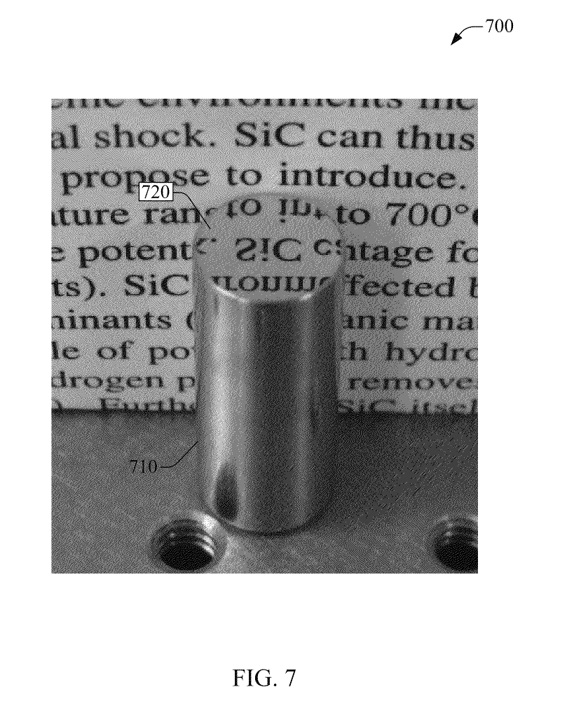

FIG. 7 illustrates a photograph 700 of an example 316 stainless steel cylinder 710 end cut with the sharp-cornered single-crystal 6H SiC tool on an ultra-precision lathe according to aspects of the subject innovation. The difference in reflectivity of end 720 when compared with end 620 is clearly visible, and is a result of the difference in surface roughness.

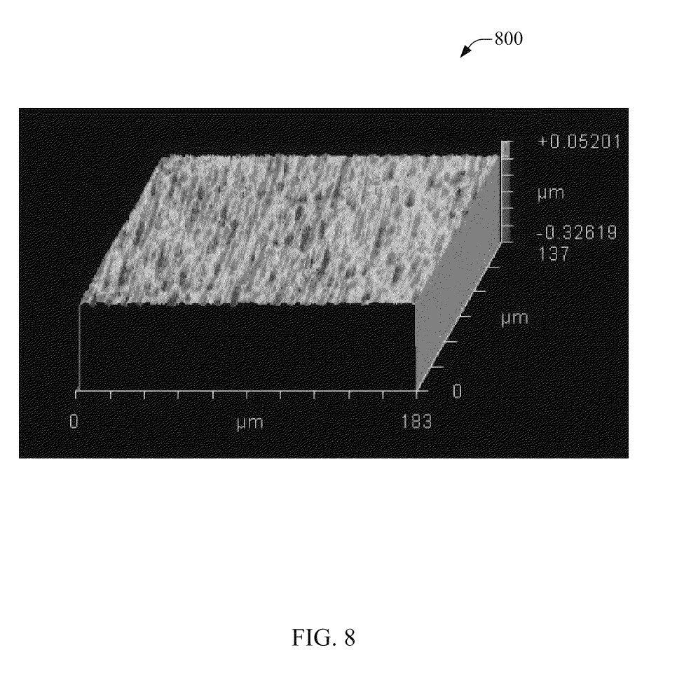

FIG. 8 illustrates a surface map 800 of the sample shown in FIG. 7, as measured with a Zygo interferometer. A common metric for quantifying surface roughness is the average surface roughness (Ra), defined to be the average distance between the measured surface and the mean plane. A quantitative analysis of the 6H SiC-cut 316 stainless steel surface at end 720 with a Zygo interferometer shows why the surface of end 720 is so reflective: the Ra is approximately 3 nm in the smoothest areas. A map of a small region of the surface of end 720 is shown in FIG. 8. The grooves from the spiral cutting pattern, while very low in amplitude, are clearly visible as slightly curved lines running approximately vertically across the graph shown in FIG. 8.

An analysis of the roughness of the surfaces cut with the large radius single-crystal 4H SiC tool 500 showed similar, although slightly rougher, results. The surfaces cut at 2000 rpm with a feed rate of 1 μm per revolution and a depth of cut of 1 μm or 3 μm had Ra of 5 nm to 6 nm in the smoothest regions, while the surface cut with a feed rate of 3 μm per revolution and a depth of cut of 1 μm had Ra of 8 nm in the smoothest regions. The surface of the nickel rod, cut with a feed rate of 1 μm per revolution and a depth of cut of 3 μm also had Ra of 6 nm in the smoothest regions.

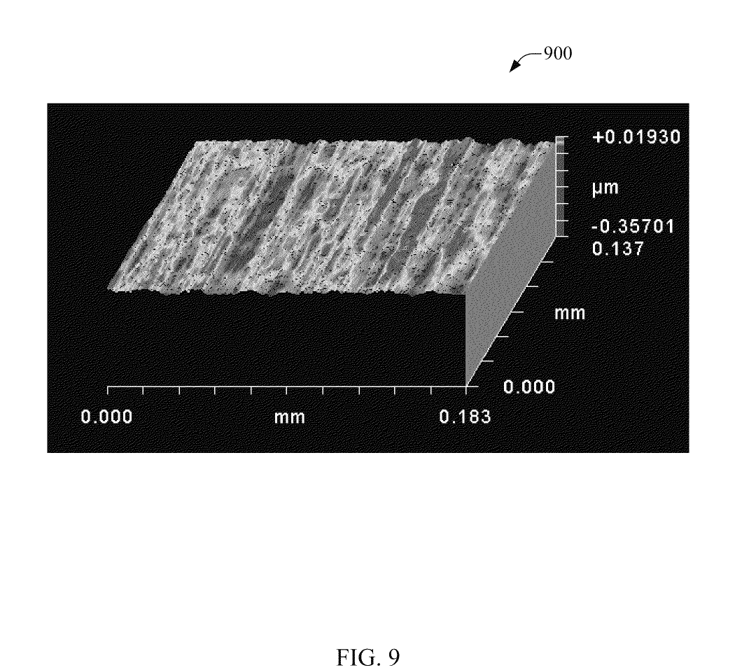

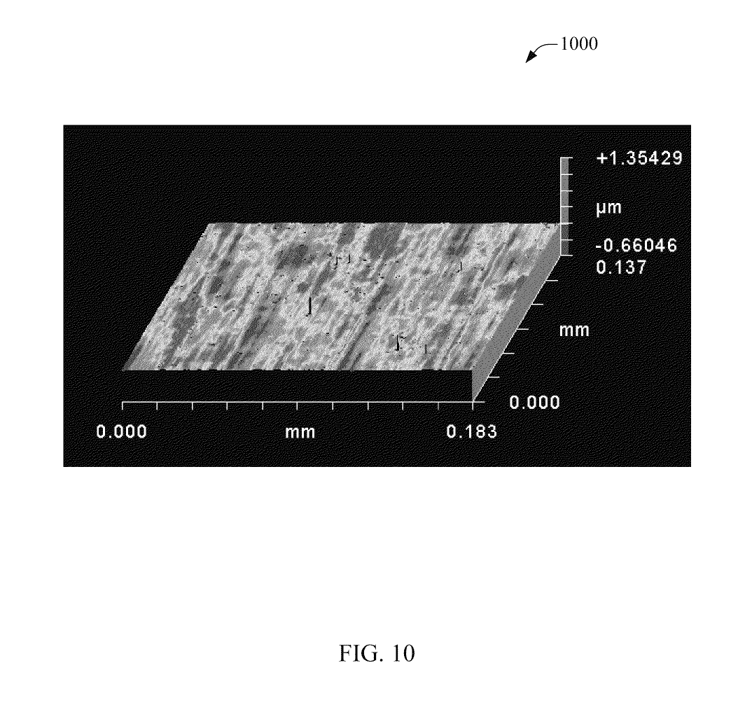

The maps of small regions of two of the surfaces cut with the large radius 4H SiC tool are shown in FIGS. 9 and 10. FIG. 9 illustrates an example surface map 900 of a portion of the end of a 316 stainless steel cylinder cut with the large radius single-crystal 4H SiC cutting tool 500 according to aspects of the subject innovation. FIG. 10 illustrates an example surface map 1000 of a portion of the end of a nickel cylinder cut with the large radius 4H SiC single-crystal cutting tool 500 in an embodiment of the innovation.

The surfaces cut with the large radius tool show less defined grooves, as expected with a much rounder ended tool. However, there is a notable increase in roughness of surface maps 900 and 1000 when compared to 800. This may be due to vibrations of the tool or sample induced by the larger cutting forces produced while cutting a wider band on each pass with a large radius tool such as tool 500. It may be possible to reduce these vibrations with careful choice of cutting speeds and feed rates, as is commonly needed in conventional machining of stainless steel, as could be appreciated by a person of skill in the art in light of the discussion herein. As an alternative, a smaller radius tool could decrease the cutting forces and provide for decreased surface roughness. However, a smaller radius tool will generally require a slower feed rate to avoid excessive grooving of the surface.

The experimental results of cutting silicon with tools according to aspects of the innovation indicate that ultra-precision machining of Si with a single-crystal SiC cutting tool such as tool 400 or tool 500 can be accomplished, but machining of Si can be sensitive to the tuning of cutting parameters and selection of crystal geometry or orientation. Experimental results indicated that clean cuts on limited areas of a silicon wafer were able to be produced with cutting tools according to aspects of the subject innovation, although these cuts did not obtain the low roughness and impressive reflectivity achieved with the cuts on stainless steel and nickel alloys discussed above. With proper selection of parameters, however, such as one or more of changing the orientation of the crystal to decrease the brittleness of the cutting tip of the tool or tuning the cutting parameters, the quality of the cutting may be improved significantly.

As discussed herein, single-crystal boule SiC ground and polished to a sharp edge (e.g., high purity 4H and 6H single-crystal SiC), as associated with aspects of the innovation, has the potential to be an alternative cutting tool for ultra-precision machining, particularly for materials where diamond wears excessively rapidly (e.g., nickel, ferrous metals such as stainless steel, etc.). Experimental results discussed herein indicate that surfaces with average roughness down to 3 nm can be achieved in ferrous metals such as 316 stainless steel with a single-crystal 6H SiC cutting tool in an ultra-precision lathe. Additionally, experimental results indicate that SiC cutting tools can be used for ultra-precision machining of silicon. Furthermore, the potential advantages of single-crystal SiC cutting tools over diamond extend beyond ferrous and nickel alloys. If the cutting performance on other materials remains at least comparable to natural diamond, the cost, available crystal size, and purity of synthetic single-crystal SiC could make it the preferred cutting tool material of the future for ultra-precision machining of a wide range of materials. Additionally, methods described herein can be used to manufacture single-crystal SiC tools capable of being used in ultra-precision machining such as with a UPL. In other aspects, methods described herein can be used to perform ultra-precision machining (e.g., via a UPL) of samples with a single-crystal SiC tool.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tool, comprising:
a single crystal of SiC, wherein the crystal is polished to a sharp edge; and
a holder, wherein the single crystal is mounted in the holder.

2. The tool of claim 1, wherein the crystal is a 4H SiC or 6H SiC polymorph.

3. The tool of claim 1, wherein the tool is mounted in an ultra-precision lathe (UPL).

4. The tool of claim 3, wherein the UPL controls the tool via computer numerical control (CNC) to cut a sample according to a defined pattern.

5. The tool of claim 4, wherein the pattern is based at least in part on a design created via one or more of computer-aided design (CAD) or computer-aided manufacturing (CAM).

6. The tool of claim 1, wherein the sharp edge has one or more sharp corners and one or more side bevels.

7. The tool of claim 1, wherein the sharp edge has a radius of curvature of between about 0.1 mm and about 20 mm.

8. The tool of claim 1, wherein the crystal is a low doped, boule grown crystal.

9. The tool of claim 1, wherein the sharp edge of the crystal is shaped as an end mill.

10. The tool of claim 1, wherein an orientation of the crystal is chosen to optimize tool performance.

11. A method of manufacturing a cutting tool, comprising:
shaping a single crystal of SiC to form a sharp edge on the crystal;
polishing the shaped crystal; and
mounting the shaped crystal in a holder.

12. The method of claim 11, wherein the crystal is a low doped, boule grown crystal.

13. The method of claim 11, wherein the sharp edge has one or more sharp corners and one or more side bevels.

14. The method of claim 11, wherein the sharp edge has a radius of curvature of between about 0.1 mm and about 20 mm.

15. The method of claim 11, wherein the crystal is a 4H SiC or 6H SiC polymorph.

16. The method of claim 11, wherein the sharp edge is formed as an end mill.

17. The method of claim 11, wherein an orientation of the crystal is chosen to optimize tool performance.

18. A method of performing ultra-precision machining, comprising:
mounting a sample in a working area of an ultra-precision lathe (UPL);
selecting cutting parameters for working on the sample; and
cutting the sample with a single-crystal SiC cutting tool based at least in part on the cutting parameters.

19. The method of claim 18, further comprising installing the single-crystal SiC cutting tool in the UPL.

20. The method of claim 18, wherein the cutting tool comprises a 4H SiC or 6H SiC polymorph.

21. The method of claim 18, wherein the cutting tool comprises a low doped, boule grown crystal.

22. The method of claim 18, further comprising controlling the tool via computer numerical control (CNC) to cut a sample according to a defined pattern.

23. The method of claim 18, wherein an orientation of the single-crystal SiC cutting tool is chosen to optimize tool performance.
